(19) United States
(12) Patent Application Publication
(10) Pub. No.: US 2018/0239184 A1
(43) Pub. Date: Aug. 23, 2018

(54) METHOD OF MANUFACTURING LIQUID CRYSTAL ALIGNMENT FILM, METHOD OF MANUFACTURING THREE-DIMENSIONAL LIQUID CRYSTAL CELL, AND THREE-DIMENSIONAL LIQUID CRYSTAL CELL

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 15/958,049

(22) Filed: Apr. 20, 2018

Related U.S. Application Data
(63) Continuation of application No. PCT/JP2016/083507, filed on Nov. 11, 2016.

(30) Foreign Application Priority Data
Nov. 12, 2015 (JP) 2015-221766

(51) Int. Cl. G02F 1/1333; G02F 1/1337; G02F 1/1339; B29C 65/66; B29C 65/02; B29C 65/00

(52) U.S. Cl. CPC G02F 1/133305; G02F 1/133723; G02F 1/1339; B29C 65/66; B29K 2701/12; B29C 66/474; G02F 2001/133742; G02F 2001/133368; G02F 2201/56; B29C 65/02

(57) ABSTRACT

An object of the present invention is to provide a method of manufacturing a liquid crystal alignment film which does not lose a function as a liquid crystal cell even in a case where three-dimensional formation is performed with a high degree of freedom, a method of manufacturing a three-dimensional liquid crystal cell using the method of manufacturing a liquid crystal alignment film, and a three-dimensional liquid crystal cell produced by the method of manufacturing a three-dimensional liquid crystal cell. A method of manufacturing a liquid crystal alignment film of the present invention includes a step of arranging a liquid crystal alignment agent to a heat-shrinkable film satisfying a heat shrinkage rate of 5% to 75%, and a step of drying the liquid crystal alignment agent arranged at 40° C. to 150° C. so as to form the liquid crystal alignment film.

### CROSS-REFERENCE TO RELATED APPLICATIONS

This application is a Continuation of PCT International Application No. PCT/JP2016/083507 filed on Nov. 11, 2016, which claims priority under 35 U.S.C. § 119(a) to Japanese Patent Application No. 2015-221766 filed on Nov. 12, 2015. The above application is hereby expressly incorporated by reference, in its entirety, into the present application.

### BACKGROUND OF THE INVENTION

### 1. Field of the Invention

The present invention relates to a method of manufacturing a liquid crystal alignment film, a method of manufacturing a three-dimensional liquid crystal cell using the method of manufacturing a liquid crystal alignment film, and a three-dimensional liquid crystal cell produced by the method of manufacturing a three-dimensional liquid crystal cell.

### 2. Description of the Related Art

In recent years, liquid crystal display devices have been developed into various forms, and flexible displays which are lightweight and can be bent have attracted attention. In a liquid crystal cell which is used in such a flexible display, a glass substrate which has been used is difficult to meet the demand for weight reduction and bending. Accordingly, various plastic substrates have been examined as a replacement for the glass substrate.

Dimming devices using a liquid crystal cell are widely used in interior decoration, building materials, vehicles, or the like. These dimming devices are also desired to be reduced in weight and to have flexibility for bending, and regarding a substrate for these uses, a plastic substrate is required to be put into practical use as a replacement for the glass substrate.

Due to such circumstances, techniques for forming a liquid crystal cell made of plastic which is lightweight and can be bent have been proposed from various viewpoints.

For example, JP1995-140451A (JP-H07-140451A) discloses a technique for holding a display panel in a curved shape in a temperature region which is equal to or higher than a glass transition temperature of a polymer for forming a plastic substrate of the display panel.

JP1994-18856A (JP-H06-18856A) discloses a technique for forming a cut at a peripheral edge part such that wrinkles are not generated by distortion stress in forming a dimming element into a shape corresponding to a three-dimensional curved glass.

JP2010-224110A discloses a technique for suppressing the occurrence of electrode peeling or cracks through a step of bending and heating a display cell formed of a plastic substrate having a transparent electrode in an amorphous state to crystallize the transparent electrode in an amorphous state.

### SUMMARY OF THE INVENTION

Recently, there has been a demand for processing a display device into a shape having a complicated curved surface such as apparel or sunglasses or a demand for installing a dimming device as a three-dimensionally curved formed body, as well as the above-described demand for simple bending.

However, as a result of the studies of the inventors, it has been found that it is difficult to perform forming into a complicated curved surface or a three-dimensionally curved formed body with a simple curving technique as in JP1995-140451A (JP-H07-140451A) and JP2010-224110A. Similarly, it has been found that it is difficult to follow a three-dimensionally curved formed body with the technique of JP1994-18856A (JP-H06-18856A).

Therefore, in fact, it is difficult to obtain a liquid crystal cell having formability into a complicated curved surface or a three-dimensionally curved formed body (hereinafter, referred to as “three-dimensional formability with a high degree of freedom).

On the other hand, means for controlling alignment of liquid crystal molecules is required in the liquid crystal cell described above and means for forming an alignment film is generally used.

In addition, the liquid crystal cell includes a pair of substrates (a first substrate and a second substrate 2), a liquid crystal layer, a spacer, a sealing material, and an alignment film. The alignment of the liquid crystal molecules in the liquid crystal layer is controlled by the alignment film formed between the pair of substrates and the liquid crystal layer.

In general, the alignment film is a film for controlling molecular arrangement states in liquid crystals and is formed of compositions with polyimide as a base. In addition, in a case where the liquid crystal molecules are aligned in a vertical direction with respect to a substrate, a hydrophobic structure such as a long chain alkyl group and a fluorine-containing group is introduced into polyimide. However, using such polyimide causes a case in which disadvantage occurs in formation of a liquid crystal alignment film by applying a liquid crystal alignment agent to a substrate.

Specifically, in a case of using such polyimide, it is required to heat polyamic acid at a high temperature (200° C. or higher) in a case of forming an alignment film. In particular, in a case of using a plastic substrate as a substrate, the substrate is deformed in the heating process, resulting in a loss of function as a liquid crystal cell.

Accordingly, an object of the present invention is to provide a method of manufacturing a liquid crystal alignment film which does not lose a function as a liquid crystal cell even in a case where three-dimensional formation is performed with a high degree of freedom, a method of manufacturing a three-dimensional liquid crystal cell using the method of manufacturing a liquid crystal alignment film, and a three-dimensional liquid crystal cell produced by the method of manufacturing a three-dimensional liquid crystal cell.

The inventors of the present invention have conducted intensive studies, and as a result, have found that a plastic substrate used in a liquid crystal cell is produced by using a heat-shrinkable film having a predetermined a heat shrinkage rate, or a laminate on which a liquid crystal alignment film is formed by heating a liquid crystal alignment agent at a relatively low temperature so as to be dried (40° C. to 150° C.) is used in order to perform heat shrinkage so that the substrate follows a desired three-dimensional shape having a high degree of freedom, and thus a function as a liquid crystal cell is not lost even in a case of performing three-dimensional formation with a high degree of freedom, and therefore have completed the present invention.

That is, it has been found that the above-described object can be achieved with the following configuration.

[1] A method of manufacturing a liquid crystal alignment film, comprising: a step of arranging a liquid crystal alignment agent to a heat-shrinkable film satisfying a heat shrinkage rate of 5% to 75%; and a step of drying the liquid crystal alignment agent arranged at 40° C. to 150° C. so as to form the liquid crystal alignment film.

[2] The method of manufacturing a liquid crystal alignment film according to [1], in which the liquid crystal alignment film has a vertical alignment performance of a rod-like liquid crystal compound.

[3] The method of manufacturing a liquid crystal alignment film according to [1] or [2], in which the liquid crystal alignment agent contains at least one compound selected from the group consisting of polyimide, polyamic acid, polyamic acid ester, acrylic acid copolymer, methacrylic acid copolymer, alkyl group-containing alkoxysilane, alkyl group-containing ammonium, and pyridinium.

[4] The method of manufacturing a liquid crystal alignment film according to any one of [1] to [3], in which the heat-shrinkable film is an unstretched thermoplastic resin film.

[5] The method of manufacturing a liquid crystal alignment film according to any one of [1] to [3], in which the heat-shrinkable film is a thermoplastic resin film stretched at a ratio that is greater than 0% and not greater than 300%.

[6] A method of manufacturing a three-dimensional liquid crystal cell using a laminate which has a plastic substrate, a conductive layer, a liquid crystal alignment film, a liquid crystal layer, a liquid crystal alignment film, a conductive layer, and a plastic substrate in order and in which at least one plastic substrate is a heat-shrinkable film satisfying a heat shrinkage rate of 5% to 75%, the method comprising, in order: 1) a step of arranging the conductive layers on two plastic substrates, respectively; 2) a step of arranging the liquid crystal alignment films on the conductive layers each arranged on the two plastic substrates, respectively by using the method of manufacturing a liquid crystal alignment film according to any one of [1] to [5]; 3) a step of producing the laminate by arranging the two plastic substrates on which the conductive layers and the liquid crystal alignment films are arranged and the liquid crystal layer in the order of the plastic substrate, the conductive layer, the liquid crystal alignment film, the liquid crystal layer, the liquid crystal alignment film, the conductive layer, and the plastic substrate; 4) a step of producing a two-dimensional liquid crystal cell by sealing the liquid crystal layer; and 5) a step of three-dimensionally processing the two-dimensional liquid crystal cell by heating.

[7] The method of manufacturing a three-dimensional liquid crystal cell according to [6], in which the two plastic substrates are the heat-shrinkable films satisfying a heat shrinkage rate of 5% to 75%.

[8] The method of manufacturing a three-dimensional liquid crystal cell according to [6] or [7], in which the three-dimensional processing step is a three-dimensional processing step accompanied by shrinkage of the plastic substrate by heating.

[9] The method of manufacturing a three-dimensional liquid crystal cell according to any one of [6] to [8], in which at least one plastic substrate has a thickness of 10 μm to 500 μm after the shrinkage.

[10] The method of manufacturing a three-dimensional liquid crystal cell according to any one of [6] to [9], in which in the two-dimensional liquid crystal cell producing step, the liquid crystal layer is sealed by arranging a sealing material so as to fill a gap between end parts of the two plastic substrates.

[11] The method of manufacturing a three-dimensional liquid crystal cell according to any one of [6] to [9], in which in the two-dimensional liquid crystal cell producing step, the liquid crystal layer is sealed by thermal fusion welding the end parts of the two plastic substrates.

[12] The method of manufacturing a three-dimensional liquid crystal cell according to any one of [6] to [11], in which the laminate producing step is a step in which the liquid crystal layer is arranged on the liquid crystal alignment film of the one plastic substrate on which the conductive layer and the liquid crystal alignment film are arranged, and then the other plastic substrate on which the conductive layer and the liquid crystal alignment film are arranged is arranged on the liquid crystal layer.

[13] The method of manufacturing a three-dimensional liquid crystal cell according to any one of [6] to [11], in which the laminate producing step is a step in which the one plastic substrate on which the conductive layer and the liquid crystal alignment film are arranged and the other plastic substrate on which the conductive layer and the liquid crystal alignment film are arranged, are arranged with a gap therebetween, and then the liquid crystal layer is arranged in the gap.

[14] A three-dimensional liquid crystal cell which is produced by the method of manufacturing a three-dimensional liquid crystal cell according to any one of [6] to [13].

According to the present invention, it is possible to provide a method of manufacturing a liquid crystal alignment film which does not lose a function as a liquid crystal cell even in a case where three-dimensional formation is performed with a high degree of freedom, a method of manufacturing a three-dimensional liquid crystal cell using the method of manufacturing a liquid crystal alignment film, and a three-dimensional liquid crystal cell produced by the method of manufacturing a three-dimensional liquid crystal cell.

### BRIEF DESCRIPTION OF THE DRAWINGS

FIG. 1A is a schematic view illustrating an example of a three-dimensional processing step in a method of manufacturing a three-dimensional liquid crystal cell according to the invention, and is a schematic view illustrating a state before heating and forming.

FIG. 1B is a schematic view illustrating an example of the three-dimensional processing step in the method of manufacturing a three-dimensional liquid crystal cell according to the invention, and is a schematic view illustrating a state after heating and forming.

FIG. 2A is a schematic view illustrating another example of the three-dimensional processing step in the method of manufacturing a three-dimensional liquid crystal cell according to the invention, and is a schematic view illustrating a state before heating and forming.

FIG. 2B is a schematic view illustrating another example of the three-dimensional processing step in the method of manufacturing a three-dimensional liquid crystal cell according to the invention, and is a schematic view illustrating a state after heating and forming.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In the present specification, parallel or perpendicular does not mean parallel or perpendicular in a strict sense but means a range of having ±5° from parallel or perpendicular.

<Method of Manufacturing Liquid Crystal Alignment Film>

A method of manufacturing a liquid crystal alignment film of the present invention includes a step of arranging a liquid crystal alignment agent to a heat-shrinkable film satisfying a heat shrinkage rate of 5% to 75%; and a step of drying the liquid crystal alignment agent arranged at 40° C. to 150° C. so as to form the liquid crystal alignment film.

In the present specification, a composition for producing a liquid crystal alignment film is referred as a “liquid crystal alignment agent”, and a film obtained by using the liquid crystal alignment agent is referred as a “liquid crystal alignment film”.

[Liquid Crystal Alignment Agent]

The liquid crystal alignment agent used in the method of manufacturing a liquid crystal alignment film of the present invention is not particularly limited as long as the agent contains a compound having an alignment performance of a liquid crystal compound in a case where the liquid crystal compound is arranged on the liquid crystal alignment film.

In the present invention, the liquid crystal alignment film preferably contains a compound having a vertical alignment performance of a rod-like liquid crystal compound.

As the liquid crystal alignment agent, at least one compound selected from the group consisting of soluble polyimide, polyamic acid, polyamic acid ester, a methacrylic acid copolymer, alkyl group-containing alkoxysilane, alkyl group-containing ammonium, and pyridinium is preferable, and at least one compound selected from soluble polyimide, polyamic acid, and polyamic acid ester is more preferable.

The term “methacrylic acid copolymer” indicates an acrylic acid copolymer or a methacrylic acid copolymer.

{Polyimide}

As a polyimide used in the present invention, various known polyimide can be used. Examples thereof include a polyimide described in page 105 of “Plastic LCD's Material Technology and Low Temperature Process, published by Technology Information Institute Co., Ltd”.

{Polyamic Acid and Polyamic Acid Ester}

As a polyamic acid and a polyamic acid ester used in the present invention, various known polyamic acids and polyamic acid esters can be used. Examples thereof include polyamic acids and polyamic acid esters disclosed in JP2014-238564A.

{Methacrylic Acid Copolymer}

As a methacrylic acid copolymer used in the present invention, various known methacrylic acid copolymers can be used. Examples thereof include methacrylic acid copolymers disclosed in JP2002-98828A, JP2002-294240A, and the like. Particularly preferable examples thereof include a methacrylic acid copolymer containing a carbazole group.

{Alkyl Group-Containing Alkoxysilane}

As alkyl group-containing alkoxysilane used in the present invention, various known alkyl group-containing alkoxysilanes can be used. Examples thereof include alkyl group-containing alkoxysilanes disclosed in JP1984-60423A (JP-S59-60423A), JP1987-269119A (JP-S62-269119A), JP1987-269934A (JP-S62-269934A), JP1987-270919A (JP-S62-270919A), WO2012/165354A, and the like. Particularly preferable examples thereof include alkoxysilanes containing a long chain alkyl group having 8 to 18 carbon atoms or an alkyl group substituted with a fluorine atom.

{Alkyl Group-Containing Ammonium}

As alkyl group-containing ammonium used in the present invention, various known alkyl group-containing ammoniums can be used. Examples thereof include alkyl group-containing ammoniums disclosed in JP2005-196015A and the like. Particularly preferable examples thereof include ammoniums containing a long chain alkyl group having 8 to 18 carbon atoms or an alkyl group substituted with a fluorine atom.

{Pyridinium}

As pyridinium used in the present invention, various known pyridiniums can be used. Examples thereof include pyridiniums disclosed in JP2005-196015A, JP2005-272422A, and the like. Particularly preferable examples thereof include a pyridinium represented by General Formula (I) disclosed in JP2005-272422A.

{Other Components}

The liquid crystal alignment agent used in the present invention may contain other components in accordance with the requirements.

Examples of such other components include polymers other than the above-described compound having an alignment performance of a liquid crystal compound, and the like. The other components can be used for enhancing solution properties and electrical properties.

Examples of the other polymers include polyester, polyamide, cellulose derivative, polyacetal, polystyrene derivative, poly(styrene-phenylmaleimide) derivative, poly(meth)acrylate, and the like. In a case where the other polymer is contained in the liquid crystal alignment agent, as a combination ratio, it is preferable that other polymer is 20 parts by mass or less, and it is particularly preferable that other polymer is 10 parts by mass or less with respect to the total 100 parts by mass of the above-described compound having an alignment performance of a liquid crystal compound.

{Solvent}

The liquid crystal alignment agent used in the present invention is preferably prepared in a liquid-like composition obtained by dispersing or dissolving, in an appropriate solvent, the above-described compound having an alignment performance of a liquid crystal compound, or the other components used as necessary.

Preferred examples of an organic solvent include N-methyl-2-pyrrolidone, γ-butyrolactone, γ-butyrolactam, N,N-dimethylformamide, N,N-dimethylacetamide, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol-n-propyl ether, ethylene glycol-i-propyl ether, ethylene glycol-n-butyl ether (butyl cellosolve), ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, diisobutyl ketone, isoamyl propionate, isoamyl isobutyrate, diisopentyl ether, ethylene carbonate, propylene carbonate, and the like. These may be used alone or in combination of two or more kinds thereof.

A concentration of solid contents in the liquid crystal alignment agent used in the present invention (ratio of the total mass of components other than the solvent in the liquid crystal alignment agent to the total mass of the liquid crystal alignment agent) is appropriately selected in consideration of viscosity, volatility, and the like, and is preferably 1% to 10% by mass.

That is, the liquid crystal alignment agent used in the present invention is applied to a surface of a plastic substrate to be described below and heated at 40° C. to 150° C. so as to be dried, and therefore a coated film which is a liquid crystal alignment film or a coated film which becomes a liquid crystal alignment film is formed.

In this case, in a case where a concentration of solid contents is 1% by mass or more, it is easy to make a film thickness of the coated film sufficient to have alignment performance. On the other hand, in a case where a concentration of solid contents is 10% by mass or less, viscosity of the liquid crystal alignment agent can be appropriately adjusted, which leads to favorable application properties.

A particularly preferable range of a concentration of solid contents varies according to a purpose of use of the liquid crystal alignment agent, and a method used in a case of applying the liquid crystal alignment agent to the plastic substrate. For example, in a case of a printing method, it is particularly preferable that a concentration of solid contents is 3% to 9% by mass, by which solution viscosity becomes 12 to 50 mPa·s. In a case of an ink jet method, it is particularly preferable that a concentration of solid contents is 1 to 5% by mass, by which solution viscosity becomes 3 to 15 mPa·s.

A temperature in a case where the liquid crystal alignment agent used in the present invention is dried, is preferably 60° C. to 140° C. and particularly preferably 80° C. to 130° C.

[Heat-Shrinkable Film]

As a heat-shrinkable film used in the method of manufacturing a liquid crystal alignment film of the present invention, a thermoplastic resin is preferably used. As the thermoplastic resin, a polymer resin having excellent optical transparency, mechanical strength, heat stability, and the like is preferable.

Examples of a polymer contained in the thermoplastic resin include a polycarbonate-based polymer; a polyester-based polymer such as polyethylene terephthalate (PET); an acrylic-based polymer such as polymethyl methacrylate (PMMA); a styrene-based polymer such as polystyrene, and a styrene-acrylonitrile copolymer (AS resin); and the like.

Examples thereof further include a polyolefin such as polyethylene and polypropylene; a polyolefin-based polymer such as a norbornene-based resin and an ethylene-propylene copolymer; an amide-based polymer such as a vinyl chloride-based polymer, nylon, and an aromatic polyamide; an imide-based polymer; a sulfone-based polymer; a polyethersulfone-based polymer; a polyether ether ketone-based polymer; a polyphenylene sulfide-based polymer; a vinylidene chloride-based polymer; a vinyl alcohol-based polymer; a vinyl butyl-based polymer; an arylate-based polymer; a polyoxymethylene-based polymer; an epoxy-based polymer; a cellulose-based polymer represented by triacetylcellulose; a copolymer copolymerized with monomer units of these polymers; and the like.

In addition, examples of the thermoplastic resin include a polymer obtained by combining two or more of the polymers exemplified above.

Means for shrinkage of the heat-shrinkable film used in present invention is not particularly limited, and examples thereof include shrinkage by stretching during the process of film formation. The effect caused by shrinkage of the film itself, shrinkage by residual distortion during film formation, shrinkage by a residual solvent, or the like can also be used.

{Heat Shrinkage Rate}

The heat shrinkage rate of the heat-shrinkable film used in the invention is 5% to 75%, preferably 7% to 60%, and more preferably 10% to 45%.

In the heat-shrinkable film used in the invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown substantially coincides with a stretching direction.

In the heat-shrinkable film used in the invention, the heat shrinkage rate in a direction perpendicular to the in-plane direction in which the maximum heat shrinkage rate is shown is preferably 0% to 5%, and more preferably 0% to 3%.

A measurement sample is cut every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the invention, the heat shrinkage rate is a value measured under the following conditions.

To measure the heat shrinkage rate, a measurement sample having a length of 15 cm and a width of 3 cm with a long side in a measurement direction was cut, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 1.

Heat Shrinkage Rate (%)=100×(L₀−L)/L₀ (Expression 1)

<Glass Transition Temperature (Tg)>

The Tg of the heat-shrinkable film used in the invention can be measured using a differential scanning calorimeter.

Specifically, the measurement was performed using a differential scanning calorimeter DSC7000X manufactured by Hitachi High-Tech Science Corporation under conditions of a nitrogen atmosphere and a rate of temperature increase of 20° C./min, and a temperature at a point where tangents of respective DSC curves at a peak top temperature of a time differential DSC curve (DDSC curve) of the obtained result and at a temperature of (peak top temperature-20° C.) intersected was set as a Tg.

<Stretching Step>

The heat-shrinkable film used in the invention may be an unstretched thermoplastic resin film, but preferably a stretched thermoplastic resin film.

The stretching ratio is not particularly limited, but preferably greater than 0% and not greater than 300%. The stretching ratio is more preferably greater than 0% and not greater than 200%, and even more preferably greater than 0% and not greater than 100% from the practical stretching step.

The stretching may be performed in a film transport direction (longitudinal direction), in a direction perpendicular to the film transport direction (transverse direction), or in both of the directions.

The stretching temperature is preferably around the glass transition temperature Tg of the heat-shrinkable film to be used, more preferably Tg±0° C. to 50° C., even more preferably Tg±0° C. to 40° C., and particularly preferably Tg±0° C. to 30° C.

In the invention, the film may be biaxially stretched simultaneously or sequentially in the stretching step. In a case of sequential biaxial stretching, the stretching temperature may be changed for each stretching in each direction.

In a case of sequential biaxial stretching, it is preferable that first, the film is stretched in a direction parallel to the film transport direction, and then stretched in a direction perpendicular to the film transport direction. The stretching temperature range in which the sequential stretching is performed is more preferably the same as a stretching temperature range in which the simultaneous biaxial stretching is performed.

<Method of Manufacturing Three-Dimensional Liquid Crystal Cell>

A method of manufacturing a three-dimensional liquid crystal cell using a laminate which has a plastic substrate, a conductive layer, a liquid crystal alignment film, a liquid crystal layer, a liquid crystal alignment film, a conductive layer, and plastic substrate in order and in which at least one plastic substrate is a heat-shrinkable film satisfying a heat shrinkage rate of 5% to 75%, is a method including, in order:

1) a step of arranging the conductive layers on two plastic substrates, respectively;

2) a step of arranging the liquid crystal alignment films on the conductive layers each arranged on the two plastic substrates, respectively by using the method of manufacturing a liquid crystal alignment film according to any one of claims 1 to 5;

3) a step of producing the laminate by arranging the two plastic substrates on which the conductive layers and the liquid crystal alignment films are arranged and the liquid crystal layer in the order of the plastic substrate, the conductive layer, the liquid crystal alignment film, the liquid crystal layer, the liquid crystal alignment film, the conductive layer, and plastic substrate;

4) a step of producing a two-dimensional liquid crystal cell by sealing the liquid crystal layer; and

5) a step of three-dimensionally processing the two-dimensional liquid crystal cell by heating.

[Plastic Substrate]

The two-dimensional liquid crystal cell which is used in the method of manufacturing a three-dimensional liquid crystal cell according to the invention is not formed of a conventional glass substrate, but formed of a plastic substrate in order to realize three-dimensional formability with a high degree of freedom. As the plastic substrate, a thermoplastic resin is preferably used, and as the thermoplastic resin, a polymer resin is preferable which is excellent in optical transparency, mechanical strength, heat stability, and the like.

Examples of the polymer included in the plastic substrate include polycarbonate-based polymers; polyester-based polymers such as polyethylene terephthalate (PET); acryl-based polymers such as polymethylmethacrylate (PMMA); styrene-based polymers such as polystyrene and acrylonitrile-styrene copolymers (AS resin); and the like.

Examples of the polymer further include polyolefins such as polyethylene and polypropylene; polyolefin-based polymers such as norbornene-based resins and ethylene-propylene copolymers; amide-based polymers such as vinyl chloride-based polymers, nylon, and aromatic polyamides; imide-based polymers; sulfone-based polymers; polyether sulfone-based polymers; polyetheretherketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; cellulose-based polymers represented by triacetylcellulose; copolymers copolymerized in units of monomers of the above polymers; and the like.

Examples of the plastic substrate also include a substrate formed by mixing two or more kinds of the polymers mentioned above as examples.

{Heat-Shrinkable Film}

In the two-dimensional liquid crystal cell used in the method of manufacturing a three-dimensional liquid crystal cell of the present invention, at least one of the two plastic substrates is a heat-shrinkable film satisfying a heat shrinkage rate of 5% to 75%, and it is preferable that the two plastic substrates are heat-shrinkable films satisfying a heat shrinkage rate of 5% to 75%.

The heat-shrinkable film to be used is the same as the heat-shrinkable film used in the above-described method of manufacturing a liquid crystal alignment film.

[Liquid Crystal Layer]

The liquid crystal layer which is used in the method of manufacturing a three-dimensional liquid crystal cell according to the present invention is not particularly limited as long as it is a continuous body with fluidity. A material state thereof is particularly preferably a rod-like liquid crystal body, and it is most preferable that a rod-like liquid crystal composition is used as a liquid crystal to form a liquid crystal cell.

Regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN). An alignment state is particularly preferably a so-called White-Taylor type drive mode in which vertical alignment is performed when voltage is OFF and cholesteric alignment state is performed when voltage is ON.

[Conductive Layer]

Any conductive layer used in the present invention is a layer which is conductive and arranged on the substrate.

In the present invention, the phase “is conductive” means that a sheet resistance value is 0.1 Ω/□ to 10,000 Ω/□ and includes a layer generally called an electrical resistivity layer.

A sheet resistance value is preferably low, and specifically, is preferably 300 Ω/□ or lower, particularly preferably 200 Ω/□ or lower, and most preferably 100 Ω/□ or lower.

Any conductive layer used in the present invention is preferably transparent. In the present invention, the term “transparent” means that light transmittance is 60% to 99%.

The light transmittance of the conductive layer is preferably 75% or higher, particularly preferably 80% or higher, and most preferably 90% or higher.

A heat shrinkage rate of any conductive layer used in the present invention is preferably close to a heat shrinkage rate of the substrate. By using such a conductive layer, it is possible that a short circuit in the conductive layer is unlikely to occur and a change in electric resistivity is suppressed to be small, the short circuit and the change occurring in associated with the shrinkage of the substrate.

Specifically, a heat shrinkage rate of the conductive layer is preferably 50% to 150%, is more preferably 80% to 120%, and still more preferably 90% to 110% with respect to a heat shrinkage rate of the substrate.

Examples of a material that can be used for any conductive layer used in the present invention include metal oxide (such as Indium Tin Oxide (ITO)); Carbon Nanotube (CNT), Carbon Nanobud (CNB), and the like; graphene; polymer conductors (such as polyacetylene, polypyrrole, polyphenol, polyaniline, and PEDOT/PSS); metal nanowires (such as silver nanowires and copper nanowires); metal mesh (such as silver mesh and copper mesh); and the like. It is preferable that the conductive layer of the metal mesh is formed by dispersing conductive fine particles such as silver and copper in a matrix, rather than formed of only a metal, from the viewpoint of a heat shrinkage rate.

The metal oxide such as ITO is a ceramic material and in a case of molding without shrinkage as in the related art, there is a problem in that a crack is easily formed by stretching action and therefore sheet resistance value significantly increases. On the other hand, utilizing the shrinkage in the present invention suppresses the occurrence of a crack, by which the problem of the related art that the sheet resistance value becomes high is improved, and therefore the metal oxide can be used for the conductive layer.

It is possible that the conductive layer having the metal mesh form or the carbon nanotube form, or in which particles such as metal nanowire are dispersed in a matrix, is easily associated with the shrinkage of the substrate by setting a shrinkage temperature of the substrate to become equal to or less than a glass transition temperature (Tg) of the matrix. This conductive layer is preferable in that occurrence of wrinkles can be suppressed and an increase of haze can be suppressed, compared to the conductive layer using the metal oxide or a polymer conductor.

[Laminate Producing Step]

A step of producing a laminate used in the present invention is a step in which the two plastic substrates on which the conductive layer and the liquid crystal alignment film are arranged, and the liquid crystal layer are arranged in the order of the plastic substrate, the conductive layer, the liquid crystal alignment film, the liquid crystal layer, the liquid crystal alignment film, the conductive layer, and the plastic substrate.

Examples of a method for arrangement so that the laminate has the order described above include a method in which the liquid crystal layer is arranged on the liquid crystal alignment film of the one plastic substrate on which the conductive layer and the liquid crystal alignment film are arranged, and then the other plastic substrate on which the conductive layer and the liquid crystal alignment film are arranged is arranged on the liquid crystal layer, a method in which the one plastic substrate on which the conductive layer and the liquid crystal alignment film are arranged and the other plastic substrate on which the conductive layer and the liquid crystal alignment film are arranged, are arranged with a gap therebetween, and then the liquid crystal layer is arranged in the gap, and the like.

A method for arranging a liquid crystal layer is not particularly limited, and various known methods such as application, and injection using capillarity can be used.

In the present invention, a liquid crystal cell is shrunk by heating so as to be three-dimensionally processed in a three-dimensional processing step to be described below. Accordingly, in the step of producing a laminate, for example, as a temperature condition for heating in a drying step of the liquid crystal alignment agent, and the like, the temperature is preferably a temperature at which heat shrinkage is performed, that is, 60° C. to 140° C. The temperature is more preferably 80° C. to 130° C. and is still more preferably 90° C. to 130° C. A time for heating is preferably a time in which deformation of the heat-shrinkable film due to extreme heating does not occur but sufficient heat is spread uniformly, that is, 3 seconds to 30 minutes. The time is more preferably 10 seconds to 10 minutes and still more preferably 30 seconds to 5 minutes.

[Two-Dimensional Liquid Crystal Cell Producing Step]

The two-dimensional liquid crystal cell producing step used in the invention is a step of sealing the liquid crystal layer produced in the arrangement step and interposed between the two plastic substrates.

The sealing method is not particularly limited, and various methods such as a method of arranging a sealing material to fill the gap between the end parts of the two plastic substrates and a method of heat-sealing the end parts of the two plastic substrates can be used.

The sealing may be completed before the three-dimensional processing step to be described later or may be performed in such a manner that in a state in which an injection port of the liquid crystal layer is opened, other parts are filled, and the injection port is filled after injection of the liquid crystal layer.

[Three-Dimensional Processing Step]

The three-dimensional processing step used in the invention is a step of three-dimensionally processing the two-dimensional liquid crystal cell by heating.

In the three-dimensional processing step used in the invention, it is preferable that the heat-shrinkable film is three-dimensionally processed by being shrunk by heating.

The temperature condition for heating the heat-shrinkable film is preferably higher than a Tg of the film to perform forming and not higher than a melting temperature of the film, that is, 60° C. to 260° C. The temperature condition is more preferably 80° C. to 230° C., and even more preferably 100° C. to 200° C. The heating time is set such that sufficient heat uniformly spreads and film decomposition does not occur by extreme heating, that is, preferably 3 seconds to 30 minutes. The heating time is more preferably 10 seconds to 10 minutes, and even more preferably 30 seconds to 5 minutes. The heat shrinkage rate of the film is preferably 5% to 75% in order to realize three-dimensional formability with a high degree of freedom. The heat shrinkage rate is more preferably 7% to 60%, and even more preferably 10% to 45%. The thickness of the heat-shrinkable film after shrinkage is not particularly limited, preferably 10 μm to 500 μm, and more preferably 20 μm to 300 μm.

In realizing the shrinkage behavior as described above, some thermoplastic resins may rarely shrink due to resin characteristics such as crystallization. For example, polyethylene terephthalate (PET) has high shrinkability in a case where it is amorphous. However, thermal stabilization may increase and shrinkage may rarely occur through polymer chain alignment and crystal fixing by strong stretching. Such a material which rarely shrinks due to the crystallization may not be preferable.

It is also preferable that the three-dimensional processing is performed after a three-dimensional liquid crystal cell precursor is made in which the two-dimensional liquid crystal cell is formed into a tubular shape.

The method for forming into a tubular shape is not particularly limited, and examples thereof include a method including rolling a sheet-like two-dimensional liquid crystal cell and pressure-bonding sides facing each other. The shape of the interior of the tube is not particularly limited. It may be an annular shape, an elliptical shape, or a free shape having a curved surface when the tube is viewed from the top. All the sides of the three-dimensional liquid crystal cell precursor are preferably sealed.

With the method of manufacturing a three-dimensional liquid crystal cell according to the invention, for example, by shrinking and forming according to a body shaped like a beverage bottle, a display device or a dimming device can be installed on the bottle, or a display device covering the vicinity of the cylindrical structure can be realized.

In the method of manufacturing a three-dimensional liquid crystal cell according to the invention, it is preferable that a peripheral length LO before shrinkage and a peripheral length L after shrinkage satisfy Expression 2 for production.

5≤100×(L0−L)/L0≤75 (Expression 2)

Here, the peripheral length L after shrinkage may be different in a plurality of places as long as it is within a range satisfying the above expression. That is, with the method of manufacturing a three-dimensional liquid crystal cell according to the invention, it is possible to perform processing into a three-dimensionally formed body with a higher degree of freedom within a range satisfying the above expression.

In addition, Expression 2 may be satisfied in a partial region in the produced three-dimensional liquid crystal cell, and Expression 2 is preferably satisfied in the entire region.

In the forming processing, in a case where a formed body with a high degree of freedom which has a peripheral length smaller than the peripheral length L0 before shrinkage is used inside, the heat-shrinkable film used in the invention shrinks toward the interior side of the tubular shape and a pressure toward the interior side of the tubular shape is applied thereto. However, in the liquid crystal layer in the sealed liquid crystal cell, the pressure is uniformly propagated to all other regions of the liquid crystal layer (so called Pascal's theorem) regardless of the shape of the liquid crystal cell even in a case where the pressure is applied to a certain point. Thus, the interior part of the liquid crystal cell is uniformly pressed by film shrinkage, and it is possible to maintain a constant cell gap. It is also particularly preferable that various spacers are arranged in advance in the liquid crystal cell to maintain a constant cell gap.

### EXAMPLES

Hereinafter, the invention will be described in detail with reference to examples. The materials, the reagents, the amounts of materials, the proportions thereof, the conditions, the operations, and the like which will be shown in the following examples can be appropriately modified within a range not departing from the gist of the invention. Accordingly, the scope of the invention is not limited to the following examples.

### Example 1

<Production of Liquid Crystal Alignment Film 101>

[Production of Heat-Shrinkable Film (Plastic Substrate)]Polycarbonate (manufactured by TEIJIN LIMITED.) having a thickness of 300 μm was heated for 1 minute at 155° C. and stretched in a transverse direction (TD) at a stretching ratio of 50%. Then, the resulting material was cut into a 10 cm (machine direction (MD))×30 cm (TD) sized piece to obtain a stretched polycarbonate film having a thickness of 150 μm, and therefore a heat-shrinkable film was formed.

The glass transition temperature (Tg) of the stretched polycarbonate film produced as described above was 150° C., and the heat shrinkage rate in the TD measured by the above-described method was 15%.

The in-plane direction in which a heat shrinkage rate is maximum was substantially coincident with the TD, and a heat shrinkage rate in the MD perpendicular thereto was 1%.

[Production of Conductive Layer]

On a surface of the heat-shrinkable film produced as described above, a conductive layer was produced by using Ag nanowire according to the method disclosed in Example 1 of US Patent App. No. 2013/0341074, and a laminate on which the conductive layer containing the Ag nanowire was laminated was produced on the heat-shrinkable film containing the stretched polycarbonate. A thickness of the coating film of the conductive layer was 15 μm.

The laminate produced as above was cut to a square of 10 cm, and then light transmittance, a sheet resistance value, and haze were measured. As a result, the light transmittance was 90%, the sheet resistance value was 40 Ω/□, and the haze was 0.65.

[Production of Polymer Layer]

A polymer layer-coating solution was produced using the following formulation.

| | |
|---|---|
| Formulation of polymer layer-coating solution | 100 parts by mass |
| BLEMMER GLM (manufactured by | |
| NOF CORPORATION) | |
| Photopolymerization initiator (IRGACURE 819 | 3 parts by mass |
| (manufactured by BASF SE)) | |
| Surfactant A | 0.5 parts by mass |
| Ethanol | An amount such that a solid content is 30% by mass |

BLEMMER GLM 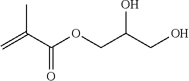
Surfactant A

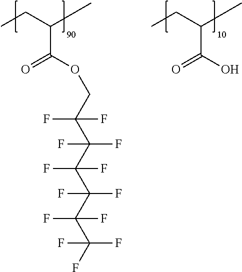

By using Bar Coater #3, the produced polymer layer-coating solution was applied on the conductive layer in an application amount by which a film thickness becomes 1.3 μm, heated so that a film surface temperature became 50° C., and then dried for 1 minute. Thereafter, under a nitrogen purge with an oxygen concentration of 100 ppm or less, irradiation of 500 mJ/cm² of ultraviolet rays was carried out using an ultraviolet irradiation device so as to proceed the polymerization reaction, and therefore a polymer layer was produced. An illuminance irradiation dose was measured at a wavelength of 365 nm. Mercury was used as a lamp. A film thickness of the polymer layer was 1.5 μm.

[Production of Liquid Crystal Alignment Film]

By using Bar Coater #1.6, a polyamic acid alignment film coating solution (JALS 684, manufactured by JSR Corporation) as a liquid crystal alignment agent was applied on the polymer layer produced as above. Thereafter, drying was performed for 3 minutes at a point where a film surface temperature reached 80° C., and therefore a liquid crystal alignment film 101 was produced. At this time, a film thickness of the liquid crystal alignment film was 60 nm.

Two sets of laminates in which the heat-shrinkable film (plastic substrate), the conductive layer, the polymer layer, and the liquid crystal alignment film, which were produced as above, were laminated in this order, were prepared.

<Production of Three-Dimensional Liquid Crystal Cell 101>

[Production of Liquid Crystal Layer]

Spherical spacers (MICROPEARL SP208 manufactured by SEKISUI FINE CHEMICAL CO., LTD.) were scattered on the liquid crystal alignment film of the laminate prepared as above, a liquid crystal composition having the following compositions was applied on the film, and therefore a liquid crystal layer was produced.

(Liquid Crystal Composition)

Drive Liquid Crystal ZLI2806 manufactured by Merck KGaA
100 parts by mass

Dichroic Dye G-241 manufactured by Japanese Res. Inst. for Photosensitizing Dyes Co., Ltd. 1.0 part by mass

Chiral Agent Cholesterol Pelargonate manufactured by Tokyo Chemical Industry Co., Ltd. 1.74 parts by mass

The laminate having the liquid crystal layer produced as above, and the other laminate produced as above were arranged so as to sandwich the liquid crystal layer therebetween. At this time, the arrangement was carried out such that a side of the liquid crystal alignment film of the laminate came into contact with the liquid crystal layer. In addition, a cell gap at this time is 8 μm, and drive liquid crystals were vertically aligned with respect to the surface of the substrate.

[Two-Dimensional Liquid Crystal Cell Production Step]

An UV adhesive was arranged as a sealing material to perform sealing so as to fill the gap between end parts of the two plastic substrates arranged as described above, and thus a two-dimensional liquid crystal cell 101 was produced.

[Three-Dimensional Processing Step]

The two-dimensional liquid crystal cell 101 produced as described above was rolled from its long side which was 30 cm long to have a cylindrical tubular shape, and then sides of 10 cm were overlapped to make an overlap of 1 cm. A pressure of 1 MPa was applied to the overlapping part for 1 minute at 200° C. for thermal pressure bonding and fixing to produce a three-dimensional liquid crystal cell precursor 101 having a tubular shape. The peripheral length was 29 cm.

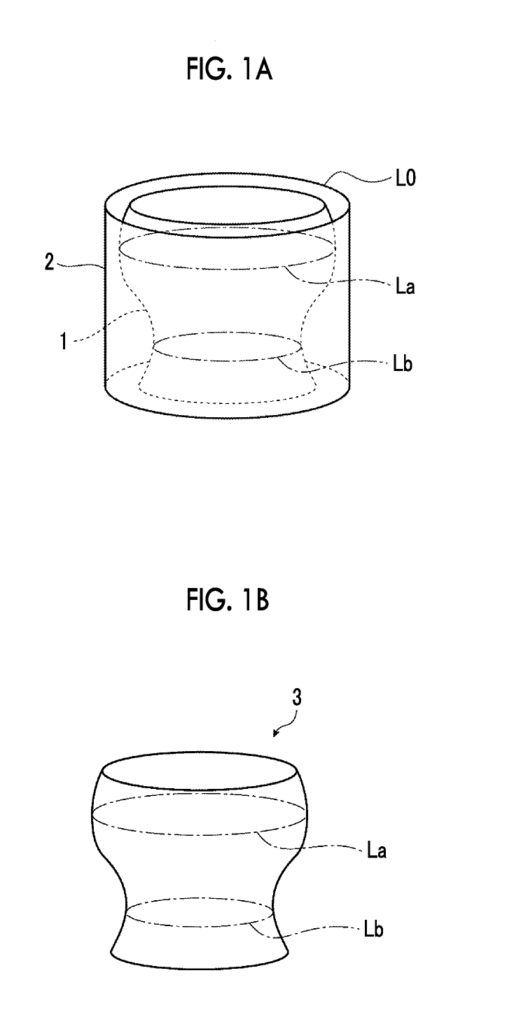

A mold 1 having a shape shown in FIG. 1A was prepared. The maximum peripheral length La was 27.5 cm, and the minimum peripheral length Lb was 26 cm. The three-dimensional liquid crystal cell precursor 101 (reference 2) having a tubular shape with a peripheral length L0 of 29 cm, which had been produced as described above, was arranged at a position shown in FIG. 1A with respect to the mold, and heated and formed for 5 minutes at a temperature of 150° C. to produce a three-dimensional liquid crystal cell 101 (reference 3) shown in FIG. 1B. It was possible to perform the forming such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were constant at 8.5 μm, and basic performance as a liquid crystal cell did not change.

The reason is thought to be that since the sealed liquid crystal cell is filled with the liquid crystal composition, the pressure is uniformly applied in the liquid crystal cell based on Pascal's theorem.

### Example 2

<Production of Three-Dimensional Liquid Crystal Cell 102>

A three-dimensional liquid crystal cell precursor 102 was prepared in the same manner as in Example 1 except that a polyimide alignment film coating solution (JALS-682-R3, manufactured by JSR Corporation) was used as the liquid crystal alignment agent in Example 1.

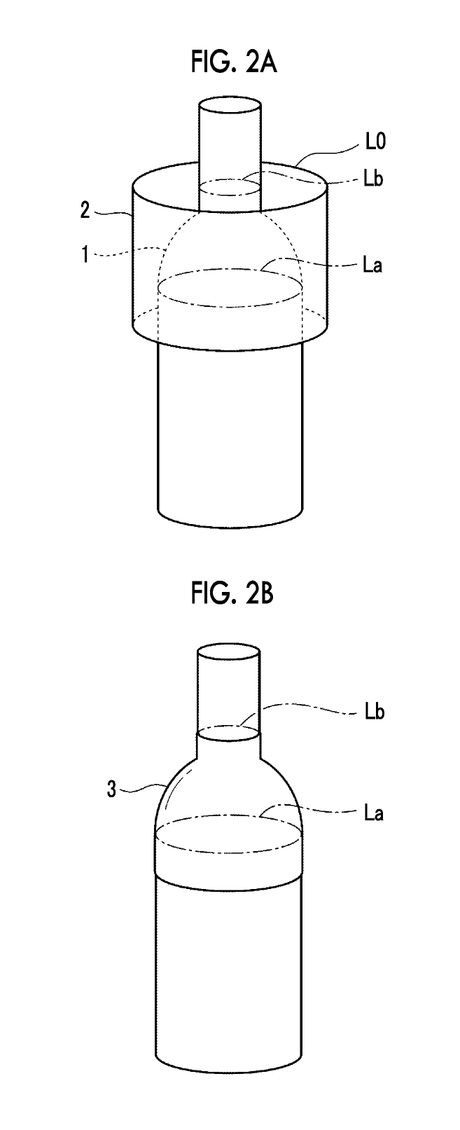

A three-dimensional liquid crystal cell 102 was prepared in the same manner as in Example 1 except that the three-dimensional liquid crystal cell precursor 102 produced as described above was used and a mold having a bottle shape shown in FIG. 2A was used.

In a mold 1 having a shape shown in FIG. 2A, the maximum peripheral length La was 27 cm, and the minimum peripheral length Lb was 25 cm. The three-dimensional liquid crystal cell precursor 102 (reference 2) having a tubular shape with a peripheral length LO of 29 cm, which had been produced as described above, was arranged at a position shown in FIG. 2A with respect to the mold, and heated and formed for 5 minutes at a temperature of 150° C. to produce a three-dimensional liquid crystal cell 102 (reference 3) as shown in FIG. 2B.

It was possible to perform the forming such that the three-dimensional liquid crystal cell precursor followed any of the part having the peripheral length La and the part having the peripheral length Lb. The peripheral lengths of the respective parts were 27 cm and 25 cm, respectively, in accordance with the shape of the mold.

In the part having the peripheral length La and the part having the peripheral length Lb, ten cell gaps were measured along the peripheral length, and as a result, the cell gaps were constant at 8.6 μm, and basic performance as a liquid crystal cell did not change.

### Example 3

<Production of Three-Dimensional Liquid Crystal Cell 103>

A three-dimensional liquid crystal cell precursor 103 was produced in the same manner as in Example 1 except that the method of manufacturing a liquid crystal alignment film in Example 1 was altered as follows.

[Production of Liquid Crystal Alignment Film]

A liquid crystal alignment agent was prepared using the following formulation.

(Liquid Crystal Alignment Agent)

Acrylic acid copolymer 103 containing a carbazole group 4 parts by mass Acetone 96 parts by mass

Acrylic Acid Copolymer 103

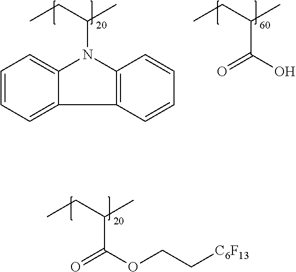

By using Bar Coater #1.6, the prepared liquid crystal alignment agent was applied on the polymer layer in an application amount by which a film thickness becomes 100 nm. Thereafter, drying was performed for 1 minute at a point where a film surface temperature reached 50° C., and therefore a liquid crystal alignment film was produced. A film thickness of the liquid crystal alignment film was 100 nm.

A three-dimensional liquid crystal cell 103 was produced in the same manner as in Example 1 by using the three-dimensional liquid crystal cell precursor 103 prepared as above.

It was possible to perform the forming such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were constant at 8.5 μm, and basic performance as a liquid crystal cell did not change.

### Example 4

<Production of Three-Dimensional Liquid Crystal Cell 104>

A three-dimensional liquid crystal cell precursor 104 was produced in the same manner as in Example 1 except that the method of manufacturing a liquid crystal alignment film in Example 1 was altered as follows.

[Production of Liquid Crystal Alignment Film]

A liquid crystal alignment agent was prepared using the following formulation.

(Liquid Crystal Alignment Agent)

Octadecyltrimethylsilane (manufactured by Tokyo Chemical Industry Co., Ltd.)
0.5 parts by mass

IPA (isopropanol)/water (95/5) 99.5 parts by mass

The produced alignment film coating solution was applied on the polymer layer using a spin coater. Thereafter, drying was performed for 1 minute at a point where a film surface temperature reached 80° C., and then the surface was washed with IPA. Therefore, a liquid crystal alignment film was produced.

A three-dimensional liquid crystal cell 104 was produced in the same manner as in Example 1 by using the three-dimensional liquid crystal cell precursor 104 produced as above.

It was possible to perform the forming such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were constant at 8.5 μm, and basic performance as a liquid crystal cell did not change.

### Example 5

<Production of Three-Dimensional Liquid Crystal Cell 105>

A three-dimensional liquid crystal cell precursor 105 was produced in the same manner as in Example 1 except that the method of manufacturing a liquid crystal alignment film in Example 1 was altered as follows.

[Production of Liquid Crystal Alignment Film]

A liquid crystal alignment agent was prepared using the following formulation.

(Liquid Crystal Alignment Agent)

| | |
|---|---|
| Cetyltrimethylammonium bromide (manufactured | 0.5 parts by mass |
| by Tokyo Chemical Industry Co., Ltd.) | |
| IPA/ethanol (50/50) | 99.5 parts by mass |

The prepared liquid crystal alignment agent was applied on the polymer layer using a spin coater. Thereafter, drying was performed for 3 minutes at a point where a film surface temperature reached 80° C., and therefore, a liquid crystal alignment film was produced.

A three-dimensional liquid crystal cell 105 was produced in the same manner as in Example 1 by using the three-dimensional liquid crystal cell precursor 105 produced as above.

It was possible to perform the formation such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were constant at 8.5 μm, and basic performance as a liquid crystal cell did not change.

### Example 6

<Production of Three-Dimensional Liquid Crystal Cell 106>

A three-dimensional liquid crystal cell precursor 106 was produced in the same operation as in Example 1 except that the stretched polycarbonate having a thickness of 150 pm was changed to an unstretched polycarbonate film (manufactured by TEIJIN LIMITED.) having a thickness of 125 μm.

A three-dimensional liquid crystal cell 106 was produced in the same operation as in Example 1 except that the three-dimensional liquid crystal cell precursor 106 was used. The peripheral lengths of the liquid crystal cell of each part were 27.8 cm and 27 cm, respectively. The shrinkage was slightly insufficient, but the following to the mold was possible.

In addition, in the part having the peripheral length La and the part having the peripheral length Lb, ten cell gaps were measured along the peripheral length, and as a result, the cell gaps were constant at 8.6 μm, and basic performance as a liquid crystal cell did not change.

### Example 7

<Production of Three-Dimensional Liquid Crystal Cell 107>

A three-dimensional liquid crystal cell precursor 107 was produced in the same manner as in Example 1, except that the sealing was performed by heat sealing for 5 seconds at 200° C. using V-300 manufactured by FUJIIMPULSE CO., LTD. instead of sealing of four sides by curing using the UV adhesive.

A three-dimensional liquid crystal cell 107 was produced in the same manner as in Example 1, except that the three-dimensional liquid crystal cell precursor 107 was used. It was possible to perform the forming such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were constant at 8.4 μm, and basic performance as a liquid crystal cell did not change.

### Example 8

<Production of Three-Dimensional Liquid Crystal Cell 108>

A three-dimensional liquid crystal cell precursor 108 of Example 8 in which a carbon nanobud was used as a conductive layer was produced in the same manner as in Example 1 except that in Example 1, instead of the Ag nanowire, a carbon nanobud was formed on a surface of a stretched polycarbonate by a direct dry-printing (DDP) method described in SID 2015 DIGEST, page 1012. A film thickness of the conductive layer was 100 nm. The liquid crystals of the cell produced were uniformly aligned vertically and showed a light blue color. In addition, an average light transmittance at 400 to 750 nm was 70%.

<Production of Three-Dimensional Liquid Crystal Cell>

The produced liquid crystal cell was fixed to the mold used in Example 1 and heated at 155° C. for 30 minutes, followed by shrinkage molding, and therefore a three-dimensional liquid crystal cell was produced. A dimensional change at this time was −10%. The produced three-dimensional liquid crystal cell had a shape conforming to the mold, no whitening or cracking occurred, and an average light transmittance at 400 to 750 nm was maintained at 70%.

A three-dimensional liquid crystal cell 108 was produced in the same manner as in Example 1 by using the three-dimensional liquid crystal cell precursor 108. It was possible to perform the forming such that the three-dimensional liquid crystal cell precursor followed any of the part having the peripheral length La and the part having the peripheral length Lb. The peripheral lengths of the respective parts were 27.5 cm and 26 cm, respectively, in accordance with the shape of the mold.

In addition, in the part having the peripheral length La and the part having the peripheral length Lb, ten cell gaps were measured along the peripheral length, and as a result, the cell gaps were constant at 8.4 μm, and basic performance as a liquid crystal cell did not change.

### Comparative Example 1

<Production of Three-Dimensional Liquid Crystal Cell 201>

A three-dimensional liquid crystal cell precursor 201 was produced in the same manner as in Example 1 except that the method of manufacturing a liquid crystal alignment film in Example 1 was altered as follows.

[Production of Liquid Crystal Alignment Film]

In Example 1, after the application of the liquid crystal alignment agent, drying was performed for 3 minutes at a point where a film surface temperature reached 200° C. in order to imidize an amic acid of the liquid crystal alignment agent, and therefore a liquid crystal alignment film was produced. However, the plastic substrate was deformed due to the high temperature and it was not possible to produce the liquid crystal cell.

### EXPLANATION OF REFERENCES

1: mold
2: three-dimensional liquid crystal cell precursor
3: three-dimensional liquid crystal cell
L0: peripheral length before shrinkage
La: maximum peripheral length
Lb: minimum peripheral length

What is claimed is:

1. A method of manufacturing a liquid crystal alignment film, comprising:
a step of arranging a liquid crystal alignment agent to a heat-shrinkable film satisfying a heat shrinkage rate of 5% to 75%; and
a step of drying the liquid crystal alignment agent arranged at 40° C. to 150° C. so as to form the liquid crystal alignment film.

2. The method of manufacturing a liquid crystal alignment film according to claim 1,
wherein the liquid crystal alignment film has a vertical alignment performance of a rod-like liquid crystal compound.

3. The method of manufacturing a liquid crystal alignment film according to claim 1,
wherein the liquid crystal alignment agent contains at least one compound selected from the group consisting of polyimide, polyamic acid, polyamic acid ester, acrylic acid copolymer, methacrylic acid copolymer, alkyl group-containing alkoxysilane, alkyl group-containing ammonium, and pyridinium.

4. The method of manufacturing a liquid crystal alignment film according to claim 2,
wherein the liquid crystal alignment agent contains at least one compound selected from the group consisting of polyimide, polyamic acid, polyamic acid ester, acrylic acid copolymer, methacrylic acid copolymer, alkyl group-containing alkoxysilane, alkyl group-containing ammonium, and pyridinium.

5. The method of manufacturing a liquid crystal alignment film according to claim 1,
wherein the heat-shrinkable film is an unstretched thermoplastic resin film.

6. The method of manufacturing a liquid crystal alignment film according to claim 2,
wherein the heat-shrinkable film is an unstretched thermoplastic resin film.

7. The method of manufacturing a liquid crystal alignment film according to claim 3,
wherein the heat-shrinkable film is an unstretched thermoplastic resin film.

8. The method of manufacturing a liquid crystal alignment film according to claim 1,
wherein the heat-shrinkable film is a thermoplastic resin film stretched at a ratio that is greater than 0% and not greater than 300%.

9. The method of manufacturing a liquid crystal alignment film according to claim 2,
wherein the heat-shrinkable film is a thermoplastic resin film stretched at a ratio that is greater than 0% and not greater than 300%.

10. The method of manufacturing a liquid crystal alignment film according to claim 3,
wherein the heat-shrinkable film is a thermoplastic resin film stretched at a ratio that is greater than 0% and not greater than 300%.

11. A method of manufacturing a three-dimensional liquid crystal cell using a laminate which has a plastic substrate, a conductive layer, a liquid crystal alignment film, a liquid crystal layer, a liquid crystal alignment film, a conductive layer, and a plastic substrate in order and in which at least one plastic substrate is a heat-shrinkable film satisfying a heat shrinkage rate of 5% to 75%, the method comprising, in order:
1) a step of arranging the conductive layers on two plastic substrates, respectively;
2) a step of arranging the liquid crystal alignment films on the conductive layers each arranged on the two plastic substrates, respectively by using the method of manufacturing a liquid crystal alignment film according to claim 1;
3) a step of producing the laminate by arranging the two plastic substrates on which the conductive layers and the liquid crystal alignment films are arranged and the liquid crystal layer in the order of the plastic substrate, the conductive layer, the liquid crystal alignment film, the liquid crystal layer, the liquid crystal alignment film, the conductive layer, and the plastic substrate;
4) a step of producing a two-dimensional liquid crystal cell by sealing the liquid crystal layer; and
5) a step of three-dimensionally processing the two-dimensional liquid crystal cell by heating.

12. The method of manufacturing a three-dimensional liquid crystal cell according to claim 11,
wherein the two plastic substrates are the heat-shrinkable films satisfying a heat shrinkage rate of 5% to 75%.

13. The method of manufacturing a three-dimensional liquid crystal cell according to claim 11,
wherein the three-dimensional processing step is a three-dimensional processing step accompanied by shrinkage of the plastic substrate by heating.

14. The method of manufacturing a three-dimensional liquid crystal cell according to claim 12,
wherein the three-dimensional processing step is a three-dimensional processing step accompanied by shrinkage of the plastic substrate by heating.

15. The method of manufacturing a three-dimensional liquid crystal cell according to claim 11,
wherein at least one plastic substrate has a thickness of 10 μm to 500 μm after the shrinkage.

16. The method of manufacturing a three-dimensional liquid crystal cell according to claim 11,
wherein in the two-dimensional liquid crystal cell producing step, the liquid crystal layer is sealed by arranging a sealing material so as to fill a gap between end parts of the two plastic substrates.

17. The method of manufacturing a three-dimensional liquid crystal cell according to claim 11,
wherein in the two-dimensional liquid crystal cell producing step, the liquid crystal layer is sealed by thermal fusion welding the end parts of the two plastic substrates.

18. The method of manufacturing a three-dimensional liquid crystal cell according to claim 11,
wherein the laminate producing step is a step in which the liquid crystal layer is arranged on the liquid crystal alignment film of the one plastic substrate on which the conductive layer and the liquid crystal alignment film are arranged, and then the other plastic substrate on which the conductive layer and the liquid crystal alignment film are arranged is arranged on the liquid crystal layer.

19. The method of manufacturing a three-dimensional liquid crystal cell according to claim 11,
wherein the laminate producing step is a step in which the one plastic substrate on which the conductive layer and the liquid crystal alignment film are arranged and the other plastic substrate on which the conductive layer and the liquid crystal alignment film are arranged, are arranged with a gap therebetween, and then the liquid crystal layer is arranged in the gap.

20. A three-dimensional liquid crystal cell which is produced by the method of manufacturing a three-dimensional liquid crystal cell according to claim 11.
